(19) United States
(12) Patent Application Publication
(10) Pub. No.: US 2013/0071672 A1
(43) Pub. Date: Mar. 21, 2013

(54) BARRIER LAYER, A PROCESS OF MAKING A BARRIER LAYER AND USES THEREOF

(71) Applicants: Xu Li, Singapore (SG); Chaobin He, Singapore (SG); Jia En Low, Singapore (SG); Siew Yee Wong, Singapore (SG)

(72) Inventors: Xu Li, Singapore (SG); Chaobin He, Singapore (SG); Jia En Low, Singapore (SG); Siew Yee Wong, Singapore (SG)

(73) Assignee: Agency for Science, Technology and Research, Connexis (SG)

(21) Appl. No.: 13/638,093

(22) PCT Filed: Mar. 29, 2010
(86) PCT No.: PCT/SG2010/000123

§ 371 Date: Dec. 3, 2012

(51) Int. Cl. C08F 216/06; C08F 10/02; B32B 27/28; C08F 10/08; C08F 10/14; B32B 27/08; C08F 8/42; C08F 10/06

(52) U.S. Cl. CPC C08F 216/06; C08F 8/42; C08F 10/02; C08F 10/06; C08F 10/08; C08F 10/14; B32B 27/08; B32B 27/283; B32B 27/28
USPC 428/447; 525/100; 427/385.5; 427/379

(57) ABSTRACT

There is provided a barrier layer comprising silicate chemically coupled to a polymer matrix. There is also provided a process for making the barrier layer and uses thereof.

### TECHNICAL FIELD

The present invention generally relates to a barrier layer for a polyolefin film and to a process for making the barrier layer for a polyolefin film.

### BACKGROUND

Plastic films made of such material as polyolefin, are known to contain a “barrier layer” which prevents or inhibits the permeation of oxygen through the plastic film. These plastic films containing barrier layers which inhibit permeation of oxygen are used as packaging materials. The barrier properties of these packaging materials can be used to wrap food, medicine and electronics and play an important role in ensuring that the wrapped product reaches the consumer in the best possible condition. The barrier layer in such packaging provides a barrier against humidity and oxygen and in some applications should be able to withstand high sterilization temperatures for food and medicine packaging.

The global market for consumer packaging in 2007 was worth close to US$410 billion and it is estimated to be growing at a pace of around 5% a year, reaching over US$470 billion in 2010.

Among the barrier materials available in the market, aluminum foil laminations provide the highest barrier properties to oxygen and water (humidity). However, they are also expensive materials and thus not suitable for high volume products or commodities. The foil layer must also be a minimum of 1 mm thick as foils any thinner than that are susceptible to pinholes. Moreover, there is also a demand for transparent packaging materials for use as a marketing tool.

Plastic represents close to 40% of all packaging materials worldwide and is growing faster than any other packaging material. The Asia Pacific region is expected to be the world's largest flexible packaging market by 2010, accounting for about one-third of total demand. Growth of packaging in Asia-Pacific will account for more than 50% of world growth over the forecast period. The growth of plastics as a packaging material is mainly attributable to advances in material properties which have led to a substitution of existing packages and the development of new applications.

Currently, plastics in the form of polyolefins such as polypropylene (PP) and polyethylene (PE) are extensively used in packaging. In general, polyolefins offer a good barrier for humidity but are easily permeated by oxygen. Therefore, improving the oxygen barrier properties is crucial for polyolefins' application in packaging. Enhanced oxygen barrier properties can be achieved through the incorporation of plate-like fillers with high aspect ratio such as clay and mica, which is impermeable to oxygen and can hinder the penetration of gas molecules across the barrier layer by formation of a tortuous diffusion path. Upon compounding these impermeable fillers into a polymer, the permeating oxygen molecules are forced to diffuse around the fillers in a random path, and hence the diffusion by a tortuous pathway leads to a decrease in permeability. However, different modeling approaches have shown that the maxima improvement is only about ⅔ compared to films with no barrier layer with filler content. This is because the tortuous path formed at low filler content of less than 10 wt % does not prevent the permeation of oxygen molecules efficiently, while polyolefin composites with high filler content always show poor processing ability and mechanical property. Moreover, the addition of fillers at high content also reduces the light transmission of the prepared composite during compounding. For these applications, known fillers are not evenly dispersed in the polymer matrix and therefore do not form an effective tortuous path. Furthermore, known fillers do not form sufficiently strong interfacial interactive forces between the filler particles and the polymer matrix, thereby leading to limited barrier performance for the permeation of oxygen.

There is a known method for forming a multi-layered barrier film whereby a polymer, such as a polyolefin or copolymers of ethylene and vinyl alcohol, is compounded with clay in the absence of an aqueous solvent and is extruded as a composite layer. However, this method does not ensure that clay at a high content of 40 wt % of total composite film content is uniformly dispersed in the polymer matrix and this poor dispersion of clay leads to comparably poorer oxygen-permeation barrier properties. Further, thermal compounding at high temperature leads to polymer decomposition resulting in higher porosity and thus higher oxygen transmission.

There is another known method for forming a barrier film whereby polyhydroxylic polymer and urethane-containing polymer is mixed in solution with dispersion agents, cross-linking agents and vermiculite, which is a type of clay with a high aspect ratio. The solution is then coated onto a polymer substrate base film. However, in addition to requiring the usage of cross-linkers, this method also does not ensure that vermiculite of up to 65 wt % of the weight of the combined weight of the polymer and the cross-linker (in other words, the content of vermiculite is up to 32.5 wt %) can be uniformly dispersed in the solution.

There is a known method for producing a container with good oxygen-permeation barrier properties whereby aqueous poly(vinyl) alcohol is mixed with another polymer, an alkali metal ion and a clay at low content. This method suffers from the disadvantage in that high contents of clay are not able to be uniformly dispersed within the film to ensure effective oxygen barrier performance.

Clay is an attractive filler type to improve the oxygen-permeation barrier properties of polymer materials. To maximize the barrier performance, hydrophilic clay is normally treated to render them compatible with hydrophobic polymer materials. The conventional surface modification approach to treat clay is to absorb a monolayer of quaternary ammonium on the clay surface. Such organically modified clay has been employed to fabricate polymer composites with improved oxygen-permeation barrier properties. A 40% drop in oxygen permeability upon the incorporation of 4 vol % organically modified clay into high density PE was reported. Nanocomposite films for food packaging have also been fabricated from PP and quaternary ammonium modified clay via extrusion. The oxygen permeability in the prepared film containing 5 wt % clay is more than 22% lower than in the PP control.

However, although organic ammonium salts have shown improved clay exfoliation and dispersion for enhancing the oxygen-permeation barrier properties, they typically have a low thermal decomposition temperature and lead to color changing during extrusion. Moreover, the interfacial interaction between clay and the polymer matrix is not strong enough to avoid gap formation around the interfacial area of clay. Thus, successful development of appropriate clay modification is extensively required for polymer nanocomposite in packaging.

Poly(vinyl alcohol) (PVA) is a biocompatible polymer material with high oxygen barrier property (O₂ permeation: about 3 cc/m²·day⁻¹ at 2 μm PVA thickness, which is determined by its molecular weight and hydrolysis degree). To further improve the oxygen barrier property of PVA, pristine clay was incorporated into PVA to form a clay/PVA nanocomposite. The oxygen permeability of the composite with clay content of 10 wt % is less than one-third of that of pure PVA. Another polymer material is PP/PVA blended film, which can be produced through extrusion. Its oxygen permeability is about 20 cc/m²·day⁻¹ at 20 μm PP/PVA thickness at PVA content of 30 wt %. However, the application of PVA for food packaging is deteriorated by its brittleness, poor processing ability and water sensitivity as it will lose its oxygen barrier property in the presence of moisture. Plasticizer is thus added to toughen PVA. With prolonged shelf time however, the added plasticizer is expected to diffuse from the system, leading to contamination and loss in PVA toughness.

There is a known method for using intercalated organic clay of to 45 wt % with polymers like PVA and polyolefin to produce a nanocomposite film. However, this method finds difficulty in uniformly dispersing the organic clay at high clay content to produce an effective barrier layer, a similar disadvantage as illustrated in above methods.

Other approaches for improving the oxygen barrier properties of polymer films include the multiple layering of polyolefins and nanocomposites in a film and the metallization of polymer films. However, these processes are complicated and come at a high cost. Although Multi-layering yields transparent films, it still has relatively high oxygen transmission. Films made by the incorporation of inorganic fillers with polymers are cheaper and industrially easier to produce, but these films however do not give good transparency and oxygen barrier.

There is a need to provide an efficient method to produce clay/polymer composite film with good oxygen barrier property that overcomes, or at least ameliorates, one or more of the disadvantages described above.

There is a need to provide transparent and flexible composite films with extremely high oxygen barrier property.

### SUMMARY

According to a first aspect, there is provided a barrier layer comprising silicate chemically coupled to a polymer matrix.

In one embodiment, the silicate may be chemically coupled to the polymer matrix by a coupling agent. The coupling agent may be a silane coupling agent. Advantageously, due to the use of a coupling agent to chemically couple the silicate to the polymer matrix, the interfacial interaction between the silicate and the polymer matrix may be improved such that a silicate-polymer composite barrier layer may be formed. Further, due to the chemical bonding between the silicate and the polymer matrix, any leakage gaps, that is gaps which would allow the transmission of oxygen gas, between the silicate and polymer matrix may be substantially prevented such that the barrier property of the barrier layer may be improved. In the barrier layer, the silicate that is in the form of sheets may be tightly stacked together to substantially improve the oxygen-inhibiting barrier properties of the barrier layer. The barrier layer may be substantially impermeable to odours and gases.

Advantageously, the coupling agent may have at least two reactive groups, each reactive group may bind to either the silicate or the polymer(s) making up the polymer matrix. In one embodiment, when the coupling agent is a glycidoxysilane compound that contains an alkoxy reactive group, the alkoxy reactive group may bind to the silicate while the glycidoxy reactive group may bind to the functional groups of the polymer(s). These functional groups on the polymer(s) may be at least one of a hydroxyl functional group, a carboxyl functional group and an amine functional group. Advantageously, due to the chemical bonding between the silicate, coupling agent and polymer matrix, a higher amount of silicate may be present in the barrier layer as compared to another barrier layer that does not employ the use of a coupling agent between the silicate and the polymer matrix. The amount of silicate in the barrier layer may be in the range of about 45 wt % and 95 wt %, based on the weight of the polymer matrix.

The barrier layer may optionally exclude the use of a cross-linking agent to link the polymer(s) together in the polymer matrix.

According to a second aspect, there is provided a process for making a barrier layer comprising the step of chemically coupling silicate to a polymer matrix to thereby form said barrier layer.

The process may comprise the step of heat treating a composite layer of silicate-polymer matrix to chemically couple the silicate in the form of silicate sheets to the polymer matrix to form the barrier layer.

According to a third aspect, there is provided a polyolefin film comprising an oxygen barrier layer, the barrier layer comprising silicate chemically coupled to a polymer matrix.

Advantageously, the polyolefin film may at least partially allow the transmission of light therethrough the film. The polyolefin film may be substantially flexible and may be able to conform to the shape and size of the material to be packaged by the polyolefin film. The polyolefin film may be substantially impermeable to moisture due to the presence of the two polyolefin layer and may be substantially impermeable to odours and gases due to the presence of the barrier layer. Accordingly, the contents of the package may be substantially protected from odour contamination and oxidation due to the absence of oxygen from the ambient environment.

### DEFINITIONS

The following words and terms used herein shall have the meaning indicated:

The term “chemically coupled”, “chemically coupling” and grammatical variants thereof, in the context of this specification, refers to the coupling of two or more chemical entities by way of a chemical bond. The term includes both a direct coupling where two or more chemical entities are bonded together by a chemical bond and indirect coupling where an intermediate entity forms a bond with one entity and another entity. For example, chemical coupling refers to the coupling between silicate and the polymer matrix that occurs when a coupling agent forms chemical bonds with both the silicate and the polymer matrix. Hence, the silicate and polymer matrix are held together via the coupling agent.

The term “clay” refers to both naturally occurring clay materials and to synthetic clay materials. Clay refers to phyllosilicate minerals and to minerals which impart plasticity and which harden upon drying or firing. See generally, Guggenheim, S. & Martin, R. T., “Definition of Clay and Clay Mineral: Joint Report of the AIPEA Nomenclature and CMS Nomenclature Committees,” Clays and Clay Minerals 43: 255-256 (1995). Materials composed of clay are characterized by having a mineral structure formed by the arrangement of octahedral units and tetrahedral units or by stacked layers formed by an octahedral sheet and one or more tetrahedral sheets of the atoms that constitute the clay structure. Illustrative are the two groups of naturally occurring clay minerals. First is the hormite group, defined here as including palygorskite and sepiolite, which have channels formed by octahedral units and tetrahedral units of the clay mineral structure. Second is the smectite group including montmorillonites and saponite, which are constituted by stacked layers formed by an octahedral sheet and more than one tetrahedral sheet, and mixtures of the foregoing. Smectite is a generic term that refers to a variety of related minerals also found in some clay deposits. Smectite is composed of units made of two silica tetrahedral sheets with a central alumina octahedral sheet. Each of the tetrahedra has a tip that points to the center of the smectite unit. The tetrahedral and octahedral sheets are combined so that the tips of the tetrahedra of each silica sheet and one of the hydroxyl layers of the octahedral sheet form a common layer. In particular, the smectite family of clay minerals includes the various mineral species montmorillonite, beidellite, nontronite, hectorite and saponite, all of which can be present in the clay mineral in varying amounts.

The term “synthetic clay” is to be interpreted broadly to include materials related in structure to layered clays and porous fibrous clays such as synthetic hectorite (lithium magnesium sodium silicate). The term “synthetic clay” may include materials that have the same chemical formula and structure as natural clays.

The term “epoxysilane” is to be interpreted broadly to refer to a compound having a molecular structure that includes at least one oxirane ring and a silicon atom bonded to hydrogen (ie —SiH). The “epoxysilane” may have an alkoxy reactive group that binds to the silicate and a glycidoxy group as the epoxy reactive group that binds to at least one of the hydroxyl, carboxyl and amine functional groups of the polymer or polymers making up the polymer matrix.

The term “gelatinous suspension” is to be interpreted broadly to refer to a liquid composition whereby one of the constituents in the liquid composition is present in a particulate semisolid form in the suspension.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/—3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DISCLOSURE OF OPTIONAL EMBODIMENTS

Exemplary, non-limiting embodiments of a barrier layer comprising silicate chemically coupled to a polymer matrix, will now be disclosed.

The silicate may be a phyllosilicate mineral. The phyllosilicate mineral may be clay or mica. The clay may be selected from the group consisting of halloysite, kaolinite, dickite, nacrite, nontronite, saponite, beidellite, illite, montmorillonite, hectorite, vermiculite, talc, palygorskite, pyrophyllite and mixtures thereof. The silicate may be synthetic clay which is synthesized based on the chemical formula and structure of known clay, such as those mentioned above. The mica may be selected from the group consisting of biotite, muscovite, phlogopite, lepidolite, margarite and glauconite. In one embodiment, the silicate is clay such as montmorillonite. It is to be appreciated that any silicate with a plate-like structure which could be exfoliated in a suitable solvent may be used.

The amount of silicate in the barrier layer may be in the range selected from the group consisting of between 45 wt % and 95 wt %, between 50 wt % and 95 wt %, between 55 wt % and 95 wt %, between 60 wt % and 95 wt %, between 65 wt % and 95 wt %, between 70 wt % and 95 wt %, between 75 wt % and 95 wt %, between 80 wt % and 95 wt %, between 90 wt % and 95 wt %, between 45 wt % and 50 wt %, between 45 wt % and 55 wt %, between 45 wt % and 60 wt %, between 45 wt % and 65 wt %, between 45 wt % and 70 wt %, between 45 wt % and 75 wt %, between 45 wt % and 80 wt %, and between 45 wt % and 85 wt %, based on the weight of the polymer matrix. In one embodiment, the amount of silicate in the barrier layer may be in the range of between 50 wt % and 90 wt %, based on the weight of the polymer matrix. The high silicate content in the barrier layer may not affect the optical properties of the barrier layer such that the barrier layer may allow light transmission through the barrier layer. This may be due to the homogeneous distribution of clay sheets and orientation of clay sheets along the polymer substrate making up the packaging film.

The silicate may be chemically coupled to the polymer matrix by a coupling agent. The coupling agent may be a silane coupling agent. The silane coupling agent may be epoxysilane. In order for the coupling agent to chemically bond with the silicate, the silicate may be dispersed in a suitable solvent to form a suspension of silicate sheets. The silicate sheets may be in the form isolated sheets or small domains consisting of a few sheets in the suspension. The solvent may be an aqueous solvent such that the silicate undergoes hydration in the presence of the aqueous solvent to expose a hydroxyl (OH) group on the surface of the silicate sheets. The presence of the hydroxyl group on the silicate sheets allow the epoxysilane to bind to the silicate sheets.

The epoxysilane may comprise an alkoxy reactive group as the reactive group which binds to the silicate. The epoxysilane may be selected from at least one of a mono-alkoxy epoxysilane, a di-alkoxy epoxysilane and a tri-alkoxy epoxysilane. Each alkoxy reactive group may have 1 to 8 carbon atoms. Hence, each alkoxy group may be independently selected from the group consisting of methoxy, ethoxy, propoxy, butoxy, pentoxy, hexoxy, heptoxy, octoxy, and isomers thereof. The epoxysilane may comprise a glycidoxy group as the expoxy reactive group, the glycidoxy group may bind to the polymer making up the polymer matrix.

An exemplary epoxysilane compound may be selected from the group consisting of epoxyhexyltrimethoxysilane, epoxyhexyltriethoxysilane, (epoxycyclohexyl)ethyltrimethoxysilane. Additional exemplary epoxysilane compounds may be obtained from U.S. Pat. No. 5,155,233, the disclosure of which is hereby incorporated by reference.

In embodiments where the epoxy of the epoxysilane compound is a glycidoxy group, the glycidoxysilane compound may be a glycidoxyalkylalkoxysilane compound or a glycidoxyalkylsilane compound. The glycidoxyalkylalkoxysilane compound may be selected from the group consisting of glycidoxymethyltrimethoxysilane, glycidoxymethyltriethoxysilane, glycidoxymethyltripropoxysilane, glycidoxyethyltrimethoxysilane, glycidoxyethyltriethoxysilane, glycidoxyethyltripropoxysilane, glycidoxypropyltrimethoxysilane, glycidoxypropyltriethoxysilane, glycidoxypropyltripropoxysilane, glycidoxypropyltri(methoxyethoxy)silane, glycidoxypropylmethyldimethoxysilane, glycidoxypropylmethyldiethoxysilane, glycidoxypropylmethyldiethoxysilane, glycidoxypropylmethyldibutoxysilane, glycidoxypropylmethyldiisopropenoxysilane, glycidoxypropyldimethylethoxysilane, glycidoxypropyldimethylmethoxysilane, glycidoxypropyldimethylpropoxysilane, glycidoxypropylmethyldiisopropenoxysilane, glycidoxypropyldiisopropylethoxysilane, glycidoxypropylbis(trimethylsiloxy)methylsilane, glycidoxybutyltrimethoxysilane, hydrolyzates thereof, and mixtures thereof. The glycidoxyalkylsilane compound may be at least one of glycidoxypropyltrimethylsilane and glycidoxypropylpentamethyldisiloxane. Additional exemplary glycidoxysilane compounds may be obtained from U.S. Pat. No. 5,115,069, the disclosure of which is hereby incorporated by reference.

As the alkoxy reactive group of the epoxysilane binds to the silicate, the epoxy reactive group may be made available for binding to the polymer in the polymer matrix. Hence, the epoxysilane coupling agent may aid in improving the interfacial interaction between the clay sheets and the polymer matrix which acts to hold the clay sheets together.

The polymer matrix may comprise a polymer or a plurality of polymers that may be capable of cross-linking with each other to form the polymer matrix. In order to chemically bind with the epoxy reactive group, the polymer(s) making up the polymer matrix may have at least a hydroxyl functional group, a carboxyl functional group and an amine functional group. In an embodiment where a single type of polymer is used, this polymer may have both of the hydroxyl group and carboxyl group in the same molecule. The hydroxyl group and carboxyl group may be disposed on the ends of a polymer chain, or on the side-chains of the backbone of a polymer chain. In addition, this polymer may include an amine functional group. In another embodiment where a plurality of polymers is used, each polymer may have the hydroxyl functional group, the carboxyl functional group or the amine functional group.

In the embodiment where the hydroxyl group and carboxyl group are on the same polymer chain as end groups or on the side-chains of the backbone of a polymer chain, this polymer may be selected from the group consisting of vinyl alcohol-acrylic acid copolymer and vinyl alcohol-methacrylic acid copolymer.

In an embodiment where a plurality of polymers is used, the polymer having a hydroxyl functional group may be selected from the group consisting of polyvinyl alcohol polymer, polyvinyl alcohol derivatives, polyvinyl alcohol copolymers, starch, starch derivatives, chitosan, chitosan derivatives, cellulose, cellulose derivatives such as cellulose ether and ester derivatives, gums, arabinans, galactans, galactomannans, proteins, various other polysaccharides and mixtures thereof. The polymer having a carboxyl functional group may be a polycarboxylic acid. The polymer having an amine functional group may be selected from the group consisting of alkylated polyallylamine, polyvinylamine, poly (diallylamine) and poly (ethyleneimine), optionally substituted at one or more nitrogen atoms with an alkyl group or a substituted alkyl group such as a trialkylammonioalkyl group.

The polyvinyl alcohol polymer comprises mainly monomer units of vinyl alcohol. The polyvinyl alcohol polymer may be obtained by subjecting acetic acid portions of a vinyl acetate polymer to hydrolysis or by hydrolyzing a polymer such as vinyl trifluoroacetate polymer, vinyl formate polymer, vinyl pivalate polymer, tert-butyl vinyl ether polymer and trimethylsilyl vinyl ether polymer. Additional exemplary polyvinyl alcohols can be obtained from U.S. Pat. No. 3,959,242, the disclosure of which is hereby incorporated by reference.

The polyvinyl alcohol copolymer may be poly(ethylene-co-vinyl alcohol) (EVOH) of varying vinyl alcohol content.

It is to be appreciated that the polymer having a hydroxyl group, in addition to those mentioned above, may be any polymer that has a substantially high oxygen barrier property when formed into a film.

The polycarboxylic acid and/or derivatives thereof may include polycarboxylic acid homopolymers, polycarboxylic acid copolymers, and mixtures thereof. The carboxylic acid homopolymers and carboxylic acid copolymers may include at least one comonomer selected from the group consisting of acrylic acid, maleic acid, methacrylic acid, itaconic acid, citraconic acid, crotonic acid, fumaric acid, acrylamide, acrylonitrile, ethylene, propylene, butylene, styrene and esters of the above acids, wherein the homopolymers or copolymers have been partially or completely neutralized with a neutralizing agent having a monovalent group. The polycarboxylic acid may be selected from the group consisting of polyacrylic acid, polymaleic acid, polymethacrylic acid, polyitaconic acid, polycitraconic acid, polycrotonic acid, polyfumaric acid, poly(ethylene-co-acrylic acid), poly(ethylene-co-methacrylic acid), poly(methyl methacrylate-co-methacrylic acid), poly(n-butyl methacrylate-co-methacrylic acid), poly(butadiene acrylic acid), poly(butadiene methacrylic acid), and the like. The polycarboxylic acid may function as a plasticizer to reinforce the polymer having the hydroxyl functional group.

A process for making the barrier layer may comprise the step of chemically coupling silicate to the polymer matrix to thereby form the barrier layer.

In order to chemically couple silicate to the polymer matrix, a coupling agent may be added to the silicate. To prepare the silicate for coupling with the coupling agent, the silicate may be uniformly dispersed into a suitable solvent to form a suspension of silicate sheets. The solvent may be an aqueous solvent such as water, acetone, tetrahydrofuran or alcohol selected from methanol, ethanol, propanol, butanol or pentanol. In embodiments where the silicate is clay, due to the hydrophilic nature of pristine clay, the clay may be uniformly dispersed in water to form a stable suspension of clay sheets under homogenization. Similarly, mica may be uniformly dispersed in water to form a stable suspension of mica sheets under homogenization.

In order to allow the coupling agent such as an epoxysilane compound to graft onto the silicate sheets and thereby form modified silicate sheets, an epoxysilane compound such as a glycidoxysilane compound may be added to the suspension of silicate sheets. However, as the glycidoxysilane compound is typically not soluble in the aqueous solvent, the silicate suspension may be subjected to a solvent exchange whereby the second solvent is capable of dissolving the glycidoxysilane compound.

The second solvent may be an organic solvent such as a ketone. The ketone solvent may be selected from the group consisting of propanone, butanone and pentanone. The solvent exchange may be undertaken by known methods in the art. In one embodiment, the solvent exchange may be undertaken by introducing the silicate suspension into the second solvent and homogenizing the mixture. Following which, the solvent mixture may be filtered and washed with the second solvent. The above steps may be repeated to obtain a silicate suspension in the second solvent.

After the silicate suspension in the second solvent is obtained, the glycidoxysilane compound may be added to the suspension. The amount of glycidoxysilane compound added to the silicate suspension may be in the range selected from the group consisting of about 5 wt % to about 15 wt %, about 10 wt % to about 15 wt % and about 5 wt % to about 10 wt %, based on weight of silicate. In one embodiment, the amount of glycidoxysilane compound added to the suspension is about 10 wt % based on the weight of silicate.

The mixture may be stirred for a period of time to allow the binding of the glycidoxysilane compound to the surfaces of the silicate sheets. The mixture may be stirred at room temperature (about 25° C.) for about 3 to about 24 hours, or for a suitable period of time for the glycidoxysilane compound to bind to the surfaces of the silicate sheets and hence introduce the glycidoxy functional groups of the surfaces of the silicate sheets.

The modified silicate sheets in the second solvent may be subjected to solvent exchange with a third solvent, the third solvent being capable of dissolving the polymer or plurality of polymers forming the polymer matrix. Each polymer may have at least one of a hydroxyl functional group, a carboxyl functional group and an amine functional group. The third solvent may be an alcohol such as methanol, ethanol, propanol, butanol or pentanol. The solvent exchange may take place according to the steps as mentioned above. In another embodiment, the third solvent may be added to the silicate/second solvent slurry followed by rotary evaporation and then repeating this process as necessary. After the solvent exchange has taken place, the polymer or polymers making up the polymer matrix are added to the silicate/third solvent slurry under homogenization at room temperature (about 25° C.) for about 1 to about 2 hours followed by condensation through rotary evaporation. The polymer or polymers may be dissolved in an aqueous solvent before adding to the silicate/third solvent slurry.

The final suspension is a gelatinous suspension of silicate/polymer(s), wherein the silicate is present in the gelatinous suspension as glycidoxy-modified silicate sheets. In one embodiment, the silicate/polymer(s) gelatinous suspension is clay-polyvinyl alcohol-polyacrylic acid (clay-PVA-PAA) gelatinous suspension.

The final concentration of the silicate/polymer(s) in the gelatinous suspension may be in the range selected from the group consisting of about 1 wt % to about 15 wt %, about 3 wt % to about 15 wt %, about 5 wt % to about 15 wt %, about 7 wt % to about 15 wt %, about 9 wt % to about 15 wt %, about 11 wt % to about 15 wt %, about 13 wt % to about 15 wt %, about 1 wt % to about 13 wt %, about 1 wt % to about 11 wt %, about 1 wt % to about 9 wt %, about 1 wt % to about 7 wt %, about 1 wt % to about 5 wt %, about 1 wt % to about 3 wt %, and about 3 wt % to about 10 wt %. In one embodiment, the final concentration is about 6 wt %. The concentration of the silicate/polymer(s) may be calculated by measuring the weight change of a part of the gelatinous suspension before and after complete drying.

In an embodiment where the polymers used are PVA and PAA, the PAA content with respect to that of PVA may be in the range selected from the group consisting of about 2 wt % to about 30 wt %, about 5 wt % to about 30 wt %, about 10 wt % to about 30 wt %, about 15 wt % to about 30 wt %, about 20 wt % to about 30 wt %, about 25 wt % to about 30 wt %, about 2 wt % to about 25 wt %, about 2 wt % to about 20 wt %, about 2 wt % to about 15 wt %, about 2 wt % to about 10 wt %, about 2 wt % to about 5 wt %, about 3 wt % to about 25 wt %.

The amount of silicate in the gelatinous suspension may be in the range selected from the group consisting of between 45 wt % and 95 wt %, between 50 wt % and 95 wt %, between 55 wt % and 95 wt %, between 60 wt % and 95 wt %, between 65 wt % and 95 wt %, between 70 wt % and 95 wt %, between 75 wt % and 95 wt %, between 80 wt % and 95 wt %, between 90 wt % and 95 wt %, between 45 wt % and 50 wt %, between 45 wt % and 55 wt %, between 45 wt % and 60 wt %, between 45 wt % and 65 wt %, between 45 wt % and 70 wt %, between 45 wt % and 75 wt %, between 45 wt % and 80 wt %, and between 45 wt % and 85 wt %, based on the weight of the PVA and PAA together. In one embodiment, the amount of silicate in the gelatinous suspension may be in the range of between 50 wt % and 90 wt %, based on the weight of the PVA and PAA together. The much higher stability of the gelatinous silicate/polymer(s) suspension in comparison to pure silicate suspension may be due to the increase in the viscosity of the suspension, which is contributed by the PVA and PAA that functions as viscosity modifiers.

The gelatinous suspension may be then applied onto a surface of a polyolefin substrate to form a composite layer thereon. Hence, a bi-layer film of silicate/polymer(s) composite layer and polyolefin layer is obtained. During application, the homogeneously dispersed silicate sheets may be aligned along to the substrate plane due to the shearing force employed on the silicate sheets. The alignment of the silicate sheets may also be facilitated by the gelatinous state of the suspension, which is similar to that of liquid crystal under shearing. The applied silicate/polymer(s) layer on the polyolefin substrate is then cured by drying the silicate/polymer(s) layer. The drying step may be undertaken in air followed by vacuum drying. The temperature used during vacuum drying may be about 50° C.

The silicate/polymer(s) composite layer may be then subjected to a heating step. The application of heat to the silicate/polymer(s) composite layer may aid in chemically coupling the glycidoxy groups on the surfaces of the modified silicate sheets with the hydroxyl, carboxyl and/or amine functional groups on the polymer(s) in the polymer matrix to form the barrier layer. For example, the glycidoxy groups on the silicate sheets may bind with the hydroxyl group from PVA or the carboxyl group from FAA. The chemical bonding between the various functional groups may improve the interfacial interaction between the modified silicate sheets and the polymer matrix. The chemical bonds may also prevent the formation of leakage gaps between the modified clay sheets and the polymer matrix, which will maintain the barrier property of the barrier layer. In the barrier layer, the lamellar silicate sheets are in continuous phase with the polymer matrix filling up the interstitial gaps.

The heating step may be undertaken when the bi-layer film is compressed together with another polyolefin film to form a polyolefin/silicate-polymer(s) composite/polyolefin tri-layer film. The temperature used during the heating step may be in the range of about 90° C. to about 140° C. In one embodiment, the temperature used is about 110° C. The heating step may be a laminating step.

In an embodiment where two polymers are used in the polymer matrix, the composition of the silicate-first polymer-second polymer composite may be depicted by the formula “x-(100-x)-y”, where x is selected from the range of about 45 wt % to about 95 wt % and y is selected from the range of about 5 wt % to about 35 wt %, based on the weight of the first polymer. In one embodiment, x may be about 70 wt % and y may be about 10 wt %. In another embodiment, x may be about 70 wt % and y may be about 20 wt %. In a further embodiment, x may be about 60 wt % and y may be about 10 wt %. In yet a further embodiment, x may be about 60 wt % and y may be about 20 wt %. “x” refers to the amount of silicate, “100-x” refers to the amount of the first polymer and “y” refers to the amount of the second polymer.

In the tri-layer film, the polyolefin in the polyolefin layer may be an olefin homopolymer, an olefin copolymer or a mixture thereof. The polyolefins may be homopolymers and copolymers of alpha-olefins containing from 2 to 8 carbon atoms. In one embodiment, the alpha-olefins may have 2 to 4 carbon atoms. The polyolefin polymer may be selected from the group consisting of polyethylene, polypropylene, polybutenes, polyisoprene, polypentene, polyhexene, polyheptene, polyoctene, vinylidene chloride, vinyl chloride, polyethylene terephthalate, polystyrene acrylonitrile, polyamides, copolymers thereof, terpolymers thereof, α-olefin propylene copolymers, and mixtures thereof. The polyethylene may be selected from the group consisting of low density polyethylene (LDPE), linear low density polyethylene (LLDPE), high density polyethylene (HDPE), ultra low density polyethylene (ULDPE), ethylene plastomers, ultra-high molecular weight polyethylene (UHMW), and combinations thereof. In one embodiment, the polyolefin polymer may be polyethylene. In another embodiment, the polyolefin polymer may be polypropylene.

Additionally, grafted polyolefins such as polyethylene with silicone, or ethylene copolymers such as ethylene n-butyl acrylate or ethylene methyl acrylate may be used.

The polyolefin film may at least partially allow light to pass through the polyolefin film. The polyolefin film may be completely optically transparent such that all of the light incident on a surface of the polyolefin film can pass through the polyolefin film and exit from the other surfaces of the polyolefin film. Due to the presence of the barrier layer in the polyolefin film, the polyolefin film may be substantially impermeable to odours and gas such as oxygen. Hence, when the polyolefin film is used as a packaging film, the contents of the package may be substantially protected from oxidation due to the substantial prevention of oxygen gas through the polyolefin film. The polyolefin film may be substantially flexible and can bend easily when a force is applied on the polyolefin film. This may allow the polyolefin film to be used in a variety of applications as the polyolefin film can be contoured according to the varying shapes and sizes of the packaged material. The polyolefin film can be envisaged as having a hierarchical structure due to the three layers of polymer and polymer composite. The polyolefin film may be substantially impermeable to moisture due to the presence of the polyolefin layers.

The polyolefin layer(s) serve as a moisture barrier layer. Hence, the polyolefin may be substituted with other polymers that have moisture barrier property such as polycarbonates or polyetherimides. Accordingly, the tri-layer film may comprise two layers of polycarbonate or polyetherimide with the barrier layer therebetween.

The oxygen transmission rate of the polyolefin film may be dependent on the composition of the silicate-polymer(s) in the barrier layer. The oxygen transmission rate of the polyolefin film when used in food packaging and personal care packaging may be in the range of about 0.05 to about 1 cc/m²·day⁻¹.

The thickness of each polyolefin layer may be about 10 to about 150 μm. The thickness of the silicate/polymer composite layer may be about 1 to about 30 μm.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram of the formation of a gelatinous clay/polymer(s) suspension.

FIG. 2 is a schematic diagram of the formation of lamellar clay/polymer(s) composite from gelatinous clay/polymer(s) suspension.

FIG. 3 is a diagram of the top view of the lamellar clay/polymer(s) composite layer.

FIG. 4 is a transmission electron microscope image of clay-PVA-PAA composite having a clay content of 80 wt %.

FIG. 5 is a TEM image of the cross-section of polyolefin/(clay-PVA-PAA) (60-40-20) film

FIG. 6 is a scanning electron microscope image obtained at 8,500×magnification showing the cross-section of clay-PVA-PAA composite film after lamination at 110° C.

FIG. 7 is a graph showing the UV-visible spectra of applied polyolefin/(clay-PVA-PAA) film and the laminated polyolefin/(clay-PVA-PAA)/polyolefin films.

FIG. 8 is a graph showing the oxygen transmission rate of laminated polyolefin/(clay-PVA-PAA/polyolefin film measured at 23° C. and at a relative humidity of 30%.

### DETAILED DESCRIPTION OF DRAWINGS

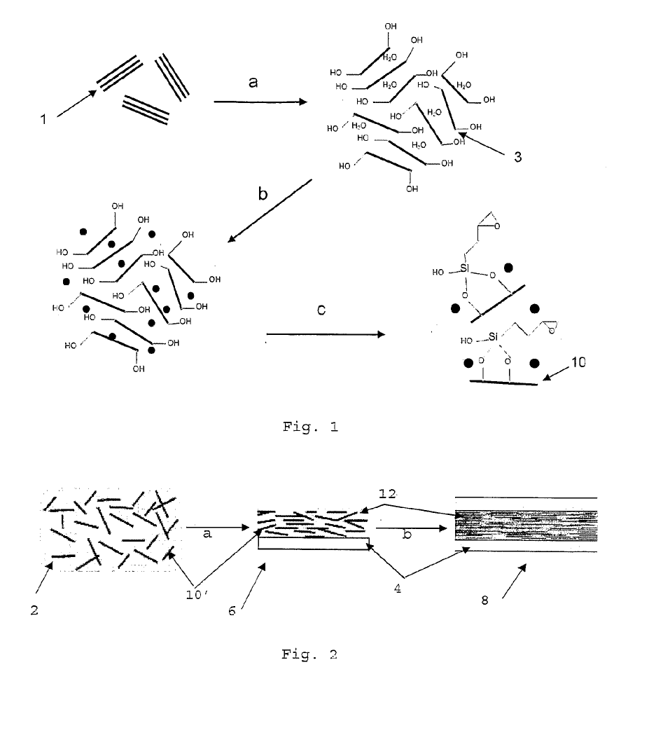

Referring to FIG. 1, a schematic diagram showing the steps involved in the formation of a gelatinous silicate/polymer(s) suspension such as gelatinous clay/polymer(s) suspension is shown.

In step (a), pristine clay 1 is dispersed in an aqueous solvent such as water to form a suspension of hydrated clay sheets 3. In step (b), a second solvent such as acetone (represented by the black dots in FIG. 1) is added and solvent exchange with the water is carried out in order to form a suspension of hydrated clay sheets in acetone solvent. In step (c), an epoxysilane compound such as a glycidoxysilane compound is added to the hydrated clay sheets 3 in order to form modified clay sheets 10 whereby the surfaces of the modified clay sheets 10 display glycidoxy reactive groups.

Referring to FIG. 2, a schematic flow chart of the formation of a three-layered film is shown. Here, like features are denoted by like reference numerals but with a prime (′) symbol. In FIG. 2, the arrangement of modified clay sheets 10′ in a clay/polymer(s) composite along the process is demonstrated.

In step (a), a suspension of the clay/polymer(s) composite 2 is applied to a polyolefin layer 4 to form a polyolefin/(clay-polymer) film 6. During application of the clay/polymer(s) composite suspension 2 to the polyolefin layer 4, the homogenously dispersed modified clay sheets 10 in the suspension 2 will be aligned along to the polyolefin plane due to the shearing force employed on them. The alignment of the modified clay sheets 10′ is also facilitated by the gelatinous state of the suspension 2. Here, a clay/polymer(s) composite layer 12 is formed adjacent to the polyolefin film 4.

The polyolefin/(clay-polymer) film 6 is then subjected to lamination in step (b) in order to form a polyolefin/(clay-polymer)/polyolefin film 8. In the polyolefin/(clay-polymer)/polyolefin film 8, it can be seen that the modified clay sheets 10′ in the clay/polymer(s) composite layer 12 are further aligned along the polyolefin plane. The interstitial gaps between the modified clay sheets 10′ are, filled up with the polymer, resulting in the formation of a clay/polymer(s) composite layer 12 with tightly stacked modified clay sheets 10′ in a lamellar structure.

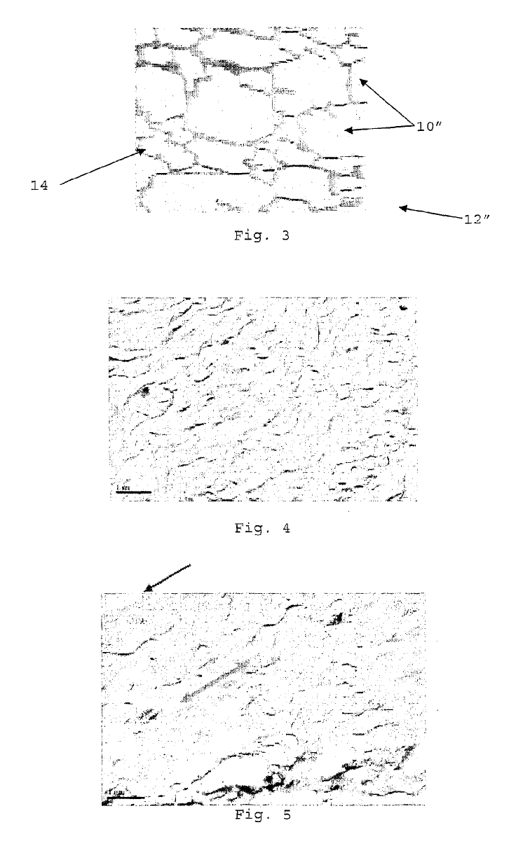

Referring to FIG. 3, the top view of the clay/polymer(s) composite layer 12″ in the polyolefin/(clay-polymer)/polyolefin film 8″ is shown. Here, like features are denoted by like reference numerals but with a double prime (“) symbol.

As shown in FIG. 3, the clay/polymer(s) composite layer 12” is made up of modified clay sheets 10″ that are in a continuous phase with the polymer 14 filling up the interstitial gaps. The chemical bonds formed between the modified clay sheets 10″ and polymer 14 help to tightly stack the modified clay sheets 10″ together as well as aid in substantially preventing the formation of leakage gaps between the modified clay sheets 10″ and polymer 14. Hence, this aids in maintaining the property of the clay/polymer(s) composite layer 12″ by acting as a barrier to a gas such as oxygen.

### EXAMPLES

Non-limiting examples of the invention will be further described in greater detail by reference to specific Examples, which should not be construed as in any way limiting the scope of the invention.

### Example 1

### Preparation of Modified Clay

2.0 g of pristine clay (montmorillonite) obtained from Nanocor Inc. of Arlington Heights of Illinois of the United States of America was mixed with 100 mL deionized water and stirred for 3 hrs followed by ultrasonication in a water-bath for 30 minutes. After stirring for another 24 hours, the mixture was homogenized using an IKA T18 Basic Ultra Turrax for 10 minutes at 14,000 rpm to obtain clay suspension in water. To exchange water with acetone, acetone was added to the suspension to a total volume of 600 mL. The mixture was then homogenized for 3 to 5 minutes at 14,000 rpm. Thereafter, the slurry precipitate was filtered with a Buchner funnel and washed with acetone. The collected slurry precipitate was re-suspended into 600 mL acetone and homogenized for 3 minutes at 14,000 rpm followed by filtration and washing. The washing process was repeated for another two times to get clay, suspension in acetone.

The slurry precipitate was transferred to a 250 mL round bottom flask and 0.2 g of 3-glycidoxypropyltrimethoxysilane (97%, obtained from Sigma-Aldrich of St. Louis of Missouri of the United States of America) (10 wt % of clay) was added. After stirring for 3 hours at room temperature (about 25° C.), the mixture was ultrasonicated for 3 minutes and stirred overnight at a speed between 300 rpm to 800 rpm.

### Preparation of Poly(Vinyl Alcohol) (PVA) Solution

1.33 g of PVA (1000 completely hydrolyzed obtained from Wako Chemicals USA, Inc of Richmond, Va. of the United States of America) was dissolved into 40 mL deionized water under stirring at 100° C.

### Preparation of Poly(Acrylic Acid) (PAA) Solution

0.26 g of PAA (MW 450,000 obtained from Polysciences, Inc. of Warrington, Pa. of the United States of America) was dissolved into 10 mL deionized water under stirring at room temperature (about 25° C.)

### Preparation of Gelatinous Clay-PVA-PAA Nanocomposite Suspension

As PVA and PAA were soluble in ethanol/water mixed solvent but insoluble in pure acetone, acetone in the slurry clay suspension has to be removed by exchanging the solvent with ethanol. Here, 100 mL ethanol was mixed into the slurry clay suspension prepared above, and the mixture was ultrasonicated in a water-bath for 3 minutes followed by rotary evaporation until the volume of the mixture was 50 mL. The acetone in the slurry clay suspension was therefore replaced by ethanol by repeating this procedure three times. The PVA and PAA solution prepared above are then mixed into the slurry clay suspension in ethanol under homogenization for 2 hours at 14,000 rpm. Finally, 40 mL of stable gelatinous clay-PVA-PAA nanocomposite suspension was prepared through rotary evaporation at 60° C. (for ethanol), followed by 75° C. (for water).

The concentration of the prepared gelatinous nanocomposite suspension was calculated by measuring its weight change before and after complete drying. Typically, 2.55 g Clay-PVA-PAA nanocomposite suspension was collected and freeze dried under high vacuum at room temperature (about 25° C.) for 3 days first. This was followed by a further high vacuum drying at 50° C. for 5 days. The weight of the dried sample was measured as 0.17 g. Therefore, the concentration of the prepared suspension was calculated as 6.7 wt %.

### Preparation of Polyolefin/(clay-PVA-PAA) Film

3 mL of gelatinous clay-PVA-PAA suspension was dropped in line on a piece of laminable polyolefin film, which had been coated with a layer of a thermal sensitive adhesive, which is mounted on the top of an Applicator machine such as Sheen Automatic Film Applicator 1137. The thickness of the polyolefin film use for lamination is about 10 to 150 μm. The gelatinous suspension was placed carefully to avoid formation of air bubbles in the suspension. A bar coater with a gap of 150 μm was run at a speed of 50 mm/s. The thickness of the clay-PVA-PAA film layer was 150 μm. The obtained polyolefin/(clay-PVA-PAA) film was first dried in air for 3 days, followed by drying in a vacuum oven for 3 days at 50° C. After vacuum drying, the film thickness of the clay-PVA-PAA film was about 5 μm. Typically, 3 mL of gelatinous suspension can produce a clay-PVA-PAA film of dimension 18 cm×14 cm with a thickness of 5 μm.

### Preparation of Polyolefin/(Clay-PVA-PAA)/Polyolefin Three-Layer Film

A laminable polyolefin film was placed on top of the polyolefin/(clay-PVA-PAA) film prepared above and the two layers were finally laminated using a Hot Laminator (IBICO IL12HR) at 110° C. with a lamination speed of 5 mm/s to produce a polyolefin/(clay-PVA-PAA)/polyolefin three-layer film.

### Characterization of Films and Results

### Transmission Electron Microscope (TEM)

TEM observation of thin sections of the composite film was performed with a transmission electron microscope (JEOL 2100) under an acceleration voltage of 200 kV. Thin sections of the composite film having a thickness of about 70 nm were cut from the prepared composite film embedded in epoxy resin under cryogenic conditions using a Leica ultramicrotome equipped with a diamond knife.

FIG. 4 is a TEM image of the clay-PVA-PAA composite when dried, showing the homogeneous dispersion of clay sheets in the dried clay-PVA-PAA composite. The clay content was 80 wt % with respect to PVA and PAA together.

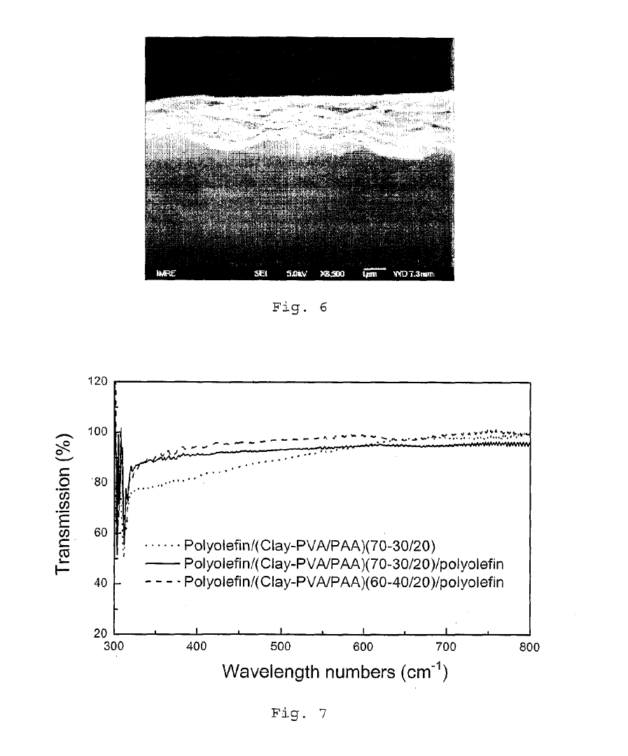

FIG. 5 is a TEM image of the cross-section of a polyolefin/(clay-PVA-PAA)(60-40-20) composite film. The composition of the clay-PVA-PAA composite is 60:40:20, the composition of PAA is with respect to that of PVA. FIG. 5 demonstrates the lamellar structure of clay sheets. The single-headed arrow denotes the substrate/film interface while the double-headed arrow denote the planar direction of the substrate.

### Scanning Electron Microscope (SEM)

SEM image of the cross-section of clay-PVA-PAA nanocomposite film after lamination at 110° C. was examined using a field emission scanning electron microscope (JEOL JSM-6700F).

FIG. 6 is a SEM image of the cross-section of a clay-PVA-PAA (70-30-20) composite film after lamination at 110° C. As shown in FIG. 6, the clay sheets were observed to form layers, confirming the lamellar structure of the clay sheets.

### UV-Visible Transmissions

UV-visible transmissions of the applied polyolefin/(clay-PVA-PAA) film and the laminated polyolefin/(clay-PVA-PAA)/polyolefin films were measured using Shimadzu UV-3101 PC spectrometer at room temperature. Pure polyolefin film was used as the reference for the polyolefin/(clay-PVA-PAA) film and laminated polyolefin film was used as the reference for the laminated polyolefin/(clay-PVA-PAA)/polyolefin films. The laminated polyolefin reference film was obtained by laminating two polyolefin films together at 110° C. and at a speed of 5 mm/s.

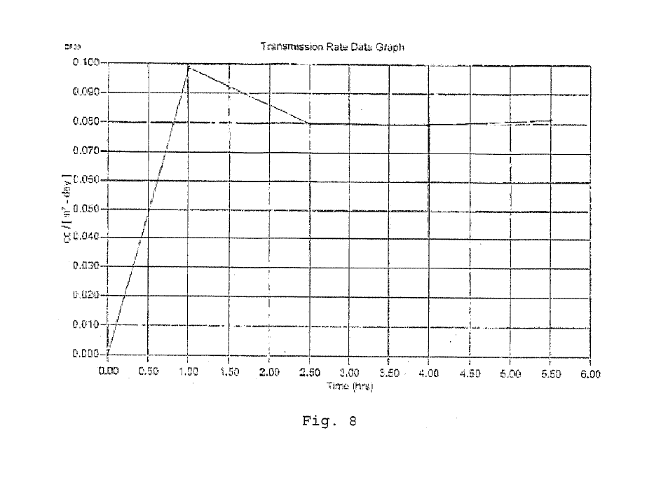

FIG. 7 is a graph showing the transmission spectra, obtained via UV-visible spectroscopy, of the applied polyolefin/(clay-PVA-PAA) composite film before and after lamination at 110° C. The numbers in the bracket such as “(70-30-20)” and “(60-40-20)” refer to the composition of the composite, the composition of PAA is with respect to that of PVA.

Polyolefin film was used as the reference for the non-laminated polyolefin/(clay-PVA-PAA) composite film while laminated polyolefin film was used as the reference for the laminated films. FIG. 7 demonstrated that the polyolefin/(clay-PVA-PAA) composite film was transparent to visible light.

### Oxygen Transmission Rate

The oxygen transmission rate of polymer film was measured using a Mocon Oxtran Model 2/21 mL. The Oxygen transmission rates of the test films were obtained at a temperature of 23° C. (1 atm of pressure) and 30% relative humidity.

FIG. 8 shows the oxygen transmission rate curve of laminated polyolefin/(Clay-PVA-PAA)(70-30-20)/polyolefin film measured at 23° C. and at a relative humidity of 30%.

Table 1 below shows the oxygen transmission rates of a number of test films. These test films are pure polyolefin film, polyolefin/polyolefin film (labeled as L-polyolefin film), polyolefin/(Clay-PVA-PAA) film, polyolefin/(Clay-PVA-PAA)/polyolefin (labeled as L-polyolefin/(Clay-PVA-PAA)) films with various composition and polyolefin/(PVA-PAA)/polyolefin (labeled as L-polyolefin/(PVA-PAA)) film. The oxygen transmission rates were measured at room temperature and at a relative humidity of 30%. The composition of the composite is depicted by the numbers in the bracket such as “(70-30-10)”, “(70-30-20)” and “(60-40-20)”, the composition of PAA is with respect to that of PVA. The “L-polyolefin/(PVA-PAA)” film serves as a reference to show the significant decrease of transmission rate.

As shown in Table 1, oxygen transmission rates of laminated polyolefin/(Clay-PVA-PAA) films, in comparison to that of laminated pure polyolefin film, were reduced significantly. The reduction in the oxygen transmission rate increased with increasing clay composition and PAA composition.

The lower transmission rate of laminated polyolefin/(Clay-PVA-PAA) composite film in comparison to that of the polyolefin/(Clay-PVA-PAA) film might be due to the tighter stacking of clay sheets in the composite layer after lamination.

The lowest oxygen transmission rate of the laminated polyolefin/(Clay-PVA-PAA) composite film was measured as 0.08 cc/m²·day⁻¹ (based on laminated polyolefin/(Clay-PVA-PAA)(70-30-20)/polyolefin film). For this test film, the thickness of the laminated Clay-PVA-PAA composite layer will be about 1.5 μm if clay was extracted, and it's transmission rate will be about 2.1 cc/m²·day⁻¹, calculated from that of pure PVA-PAA film proportionally. Therefore, the transmission rate of the prepared polyolefin/(Clay-PVA-PAA) composite layer is about 26 times lower than that of pure PVA-PAA if the barrier property was contributed from PVA-PAA only. Hence, the decrease in the transmission rate is due to the presence of clay in the composite layer, the orientation of exfoliated clay sheet along the polymer substrate and the tightly stacked high content clay.

TABLE 1
Oxygen Transmission Rates of Various Test Films

| | Transmission Rate |
|---|---|
| Type of Film* | (cc/m² · day⁻¹) |
| Polyolefin film | 24.68 |
| L-polyolefin film | 14.46 |
| Polyolefin/(Clay-PVA-PAA) film | 1.34 |
| (70-30-10) | |
| L-Polyolefin/(Clay-PVA-PAA) film | 0.53 |
| (70-30-10) | |
| L-Polyolefin/(Clay-PVA-PAA) film | 0.08 |
| (70-30-20) | |
| L-Polyolefin/(Clay-PVA-PAA) film | 0.24 |
| (60-40-20) | |
| L-Polyolefin/(PVA-PAA) film | 0.63 |
| (80-20) | |

*Thickness of the clay-PVA-PAA composite film was controlled at about 5 μm

### APPLICATIONS

Advantageously, the oxygen barrier property of the disclosed clay/polymer composite film is extremely high.

Advantageously, the composite film comprises modified clay which forms chemical bonds with the polymer to form a strong clay/polymer composite.

Advantageously, the composite film comprises as high as 90 wt % of uniformly dispersed clay, which enhances the oxygen barrier property of the disclosed film.

Advantageously, the film also exhibits good moisture barrier property, odour barrier property and is transparent and flexible.

Advantageously, the disclosed process for the production of the clay/polymer composite film is relatively easy and at relatively low cost. The process and the resultant composite film will be an advantage in the food packaging industry, medicine packaging industry, personal care packaging industry and electronic packaging industry.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A barrier layer comprising silicate chemically coupled to a polymer matrix.

2. The barrier layer according to claim 1, wherein said silicate is chemically coupled to said polymer matrix by a coupling agent.

3. The barrier layer according to claim 2, wherein said coupling agent is a silane coupling agent.

4. The barrier layer according to claim 3, wherein said silane coupling agent is an epoxysilane.

5. The barrier layer according to claim 4, wherein said epoxysilane comprises an alkoxy reactive group as the reactive group which binds to said silicate.

6. The barrier layer according to claim 5, wherein said epoxysilane is selected from at least one of a mono-alkoxy epoxysilane, a di-alkoxy epoxysilane and a tri-alkoxy epoxysilane.

7. The barrier layer according to claim 6, wherein each alkoxy reactive group has 1 to 8 carbon atoms.

8. The barrier layer according to claim 5, wherein said epoxysilane comprises a glycidoxy group as the expoxy reactive group.

9. The barrier layer according to claim 8, wherein said epoxysilane comprises glycidoxypropyltrimethoxysilane and analogues thereof.

10. The barrier layer according to claim 1, wherein said silicate is selected from the group consisting of clay, synthetic clay and mica.

11. The barrier layer according to claim 10, wherein said clay is montmorillonite.

12. The barrier layer according to claim 1, wherein the amount of said silicate in said barrier layer is in the range of between 45 wt % and 95 wt %, based on the weight of the polymer matrix.

13. The barrier layer according to claim 1, wherein said polymer matrix comprises at least one of hydroxyl, carboxyl and amine functional groups.

14. The barrier layer according to claim 13, wherein said at least one hydroxyl, carboxyl and amine functional groups are disposed on the ends of a polymer chain.

15. The barrier layer according to claim 13, wherein said at least one of the hydroxyl, carboxyl and amine functional groups are disposed on side-chains of the backbone of a polymer chain.

16. The barrier layer according to claim 14, wherein said polymer chain having hydroxy and carboxy functional groups is selected from the group consisting of vinyl alcohol-acrylic acid copolymer and vinyl alcohol-methacrylic acid copolymer.

17. The barrier layer according to claim 13, wherein a polymer having a hydroxyl functional group is selected from the group consisting of polyvinyl alcohol polymer, poly(ethylene-co-vinyl alcohol), and derivatives thereof.

18. The barrier layer according to claim 13, wherein a polymer having a carboxyl functional group is a polycarboxylic acid selected from the group consisting of polyacrylic acid, polymaleic acid, polymethacrylic acid, polyitaconic acid, polycitraconic acid, polycrotonic acid, polyfumaric acid, poly(ethylene-co-acrylic acid), poly(ethylene-co-methacrylic acid), poly(methyl methacrylate-co-methacrylic acid), poly(n-butyl methacrylate-co-methacrylic acid), poly(butadiene acrylic acid), poly(butadiene methacrylic acid), and derivatives thereof.

19. The barrier layer according to claim 1, wherein said silicate is in the form of silicate sheets in said barrier layer.

20. A process for making a barrier layer comprising the step of chemically coupling silicate to a polymer matrix to thereby form said barrier layer.

21. The process according to claim 20, further comprising the step of modifying the surface of said silicate with a coupling agent to graft the coupling agent thereon.

22. The process according to claim 21, further comprising the step of adding a polymer material to said silicate to thereby form a suspension, wherein said polymer is capable of forming said polymer matrix.

23. The process according to claim 22, further comprising the steps of applying said suspension onto a substrate layer and curing the suspension to form a composite layer thereon.

24. The process according to claim 23, further comprising the step of heating said composite layer to chemically couple said silicate to said polymer matrix and thereby form said barrier layer.

25. The process according to any one of claims 20 to 24, wherein the silicate is in the form of silicate sheet.

26. A polyolefin film comprising an oxygen barrier layer, said barrier layer comprising silicate chemically coupled to a polymer matrix.

27. The polyolefin film according to claim 26, wherein said polyolefin is selected from the group consisting of polyethylene, polypropylene, polybutenes, polyisoprene, polypentene, polyhexene, polyheptene, polyoctene, vinylidene chloride, vinyl chloride, polyethylene terephthalate, polystyrene acrylonitrile, polyamides, copolymers thereof, terpolymers thereof, α-olefin propylene copolymers, and mixtures thereof.

28. The polyolefin film according to claim 26, wherein said barrier layer is provided between two layers of polyolefin.

29. The polyolefin film according to claim 26, wherein the amount of said silicate in said barrier layer is in the range of between 45 wt % and 95 wt %, based on the weight of the polymer matrix.
